(19) United States
(12) Patent Application Publication
(10) Pub. No.: US 2023/0309018 A1
(43) Pub. Date: Sep. 28, 2023

(54) Power Efficient Downlink Control Information Framework for Cellular Communication

(71) Applicant: Apple Inc., Cupertino, CA (US)

(72) Inventors: Johnson O. Sebeni, Fremont, CA (US); Yang Li, Plano, TX (US); Zhu Ji, San Jose, CA (US); Sami M. Almalfouh, San Jose, CA (US); Faraz Faheem, Santa Clara, CA (US); Jianxiong Shi, Dublin, CA (US); Sarma V. Vangala, San Jose, CA (US); Sreevalsan Vallath, Dublin, CA (US); Haitong Sun, Irvine, CA (US); Yuchul Kim, Santa Clara, CA (US); Wei Zeng, San Diego, CA (US); Dawei Zhang, Saratoga, CA (US)

(21) Appl. No.: 18/325,821

(22) Filed: May 30, 2023

Related U.S. Application Data
(62) Division of application No. 16/139,404, filed on Sep. 24, 2018.
(60) Provisional application No. 62/573,772, filed on Oct. 18, 2017.
(60) Provisional application No. 62/587,345, filed on Nov. 16, 2017.

(51) Int. Cl. H04W 52/02; H04W 76/28; H04W 28/02; H04L 5/00; H04W 8/24; H04W 72/20; H04W 72/23

(52) U.S. Cl. CPC H04W 52/0216; H04W 52/0274; H04W 76/28; H04W 28/0278; H04L 5/0055; H04W 8/245; H04W 8/24; H04L 5/0053; H04W 72/20; H04W 72/23; H04W 76/27

(57) ABSTRACT

This disclosure relates to performing cellular communication using a power efficient downlink control information framework. A wireless device and a cellular base station may exchange configuration information indicating that the cellular base station and the wireless device support a sleep downlink control information (sDCI) format. An sDCI configuration according to the sDCI format may be negotiated, including selecting at least one sDCI configuration parameter based at least in part on an application type currently associated with cellular communication between the cellular base station and the wireless device. Downlink control information may be provided during one or more subframes in accordance with the sDCI configuration. One or more subframes for which no downlink control information will be provided to the wireless device may be determined based at least in part on the sDCI configuration.

### PRIORITY INFORMATION

This application is a divisional of U.S. patent application Ser. No. 16/139,404, entitled “Power Efficient Downlink Control Information Framework for Cellular Communication,” filed Sep. 24, 2018, which claims priority to U.S. provisional patent application No. 62/573,772, entitled “Power Efficient Downlink Control Information Framework for Cellular Communication,” filed Oct. 18, 2017, and to U.S. provisional patent application No. 62/587,345, entitled “Power Efficient Downlink Control Information Framework for Cellular Communication,” filed Nov. 16, 2017, which are hereby incorporated by reference in their entirety as though fully and completely set forth herein.

### FIELD

The present application relates to wireless communications, and more particularly to systems, apparatuses, and methods for providing a power efficient downlink control information framework for cellular communication.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), IEEE 802.16 (WiMAX), BLUETOOTH™, etc.

The ever increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus it is very important to also reduce power requirements for wireless communications while allowing the UE device to maintain good transmit and receive abilities for improved communications. Accordingly, improvements in the field are desired.

### SUMMARY

Embodiments are presented herein of apparatuses, systems, and methods for providing a power efficient downlink control information framework for cellular communication.

According to the techniques described herein, it may be possible for a wireless device and a cellular network that provides cellular service to the wireless device to negotiate to enable a sleep downlink control information configuration, if both can support such a configuration. Such a configuration may provide a mechanism for the wireless device and its serving base station to determine portions of time (e.g., subframes or slots) in which downlink control information may be provided to the wireless device (e.g., if there is a grant or other downlink control information to be provided to the wireless device), as well as portions of time in which it is mutually agreed that no downlink control information will be provided to the wireless device.

Any of multiple possible frameworks may be used for the sleep downlink control information configuration. For example, a periodic configuration may be used in which certain periodically occurring subframes may be specified as subframes that may be used for downlink control information for the wireless device. For the remainder of subframes, it may be possible to dynamically determine that some can also be used to provide downlink control information for the wireless device, e.g., if one or more recent previous subframes included downlink control information for the wireless device, and it may be possible to determine that others may not be used for downlink control information for the wireless device. A dynamic configuration may also be used, in which it may be possible for the serving base station to directly indicate time portions for which the serving base station will not provide downlink control information for the wireless device. Still further, a hybrid dynamic-periodic configuration, which may potentially include dynamic and periodic features, may also be possible.

Negotiation to agree to use such a configuration, and potentially to determine parameters of such a configuration, may include any of various types of signaling between the wireless device and its serving base station. An agreement to use such a configuration may be temporary (e.g., may extend for a limited duration, though the duration may be extendible) or indefinite, and may be based on any of numerous possible considerations. In some instances, such an agreement, and/or the parameters of such an agreement, may be based at least in part on an application in use by the wireless device. For example, some applications may be more well-suited than others to use of a sleep downlink control information configuration, or even more well-suited to one particular sleep downlink control information framework than to another, e.g., due to its typical communication pattern(s).

Thus, use of a sleep downlink control information configuration may allow a wireless device to reduce its power consumption, for example by entering a reduced power ‘sleep’ mode during those time portions that the wireless device has determined that no downlink control information will be provided to the wireless device based on the sleep downlink control information configuration in effect. Further, it may be possible that such a power consumption reduction may come at a minimal cost in regard to network communication throughput or delay, e.g., if used with appropriately selected parameters in conjunction with an application with a relatively predictable, expected, or known communication pattern that can be accommodated by the sleep downlink control information configuration.

Note that the techniques described herein may be implemented in and/or used with a number of different types of devices, including but not limited to base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a communication flow diagram illustrating aspects of an exemplary possible method for providing a power efficient downlink control information framework for cellular communication, according to some embodiments;

FIG. 6 illustrates an exemplary possible cellular communication timeline including a framework for enabling application specific communication features, according to some embodiments;

FIGS. 7A-7M illustrate exemplary possible aspects of a message framework for negotiating use of a power efficient downlink control information framework for cellular communication, according to some embodiments;

FIG. 8 illustrates an aspect of an exemplary possible framework for indicating a grant blanking duration in a dynamic power efficient downlink control information framework for cellular communication, according to some embodiments;

FIGS. 9-14 illustrate aspects of exemplary possible cellular communication timelines that might occur using various possible operational modes of a power efficient downlink control information framework, according to some embodiments;

FIG. 15 illustrates an exemplary possible cellular communication timeline in which multiple possible operational modes of a power efficient downlink control information framework are used at various times, according to some embodiments;

FIGS. 16-21 are communication flow diagrams illustrating exemplary possible message flows that may be used in conjunction with a power efficient downlink control information framework, according to some embodiments;

FIG. 22 illustrates two possible scenarios in which a base station detects that discontinuous transmission has occurred in an active sDCI session, according to some embodiments;

FIG. 23 illustrates two possible scenarios in which a base station erroneously detects a NACK in an active sDCI session, according to some embodiments;

FIG. 24 illustrates two possible scenarios in which a base station erroneously detects an ACK in an active sDCI session, according to some embodiments;

FIG. 25 illustrates possible handling options for a base station with respect to the RV field for a second transmission when considering error cases and when ignoring error cases, according to some embodiments;

FIGS. 26-27 illustrate aspects of a possible technique for a UE to handle when a base station does not honor sDCI indications, according to some embodiments;

FIGS. 28-29 illustrate aspects of a possible technique for a UE to handle when a base station uses an RV other than 0 in an initial transmission, according to some embodiments; and

FIG. 30 illustrates aspects of possible techniques for handling uplink scheduling requests and buffer status reports in conjunction with sleep downlink control information, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)— any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element—refers to various elements or combinations of elements that are capable of performing a function in a device, e.g. in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

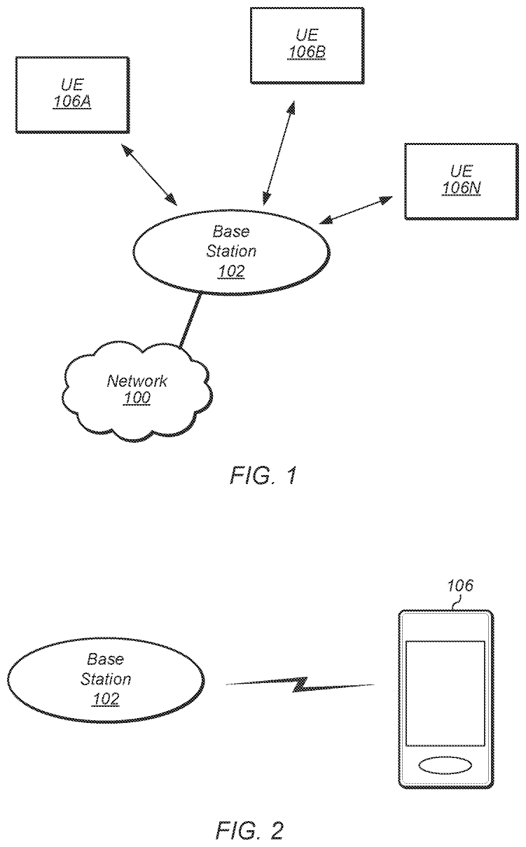

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform cellular communication using a power efficient downlink control information framework, at least according to the various methods as described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM, etc.), and separate radios for communicating using each of Wi-Fi and BLUETOOTH™. Other configurations are also possible.

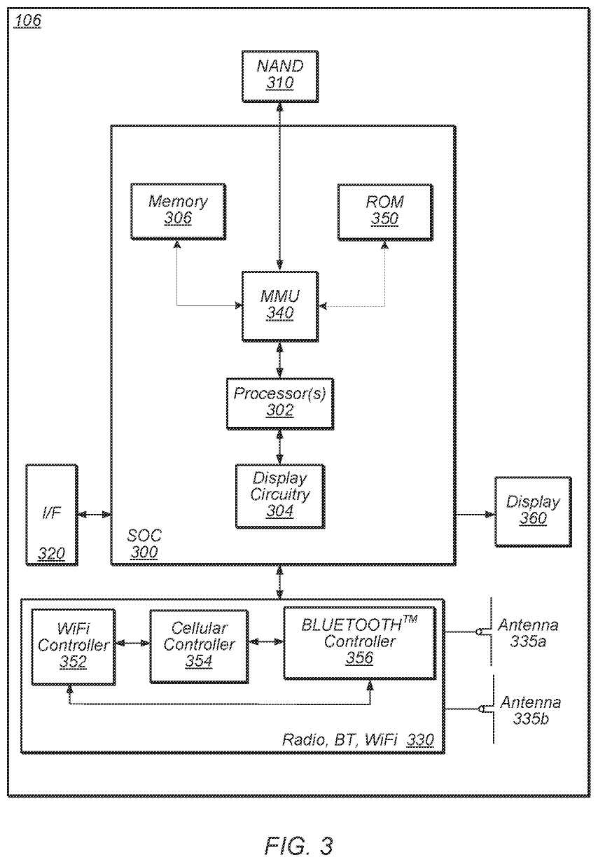

FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

As described further subsequently herein, the UE 106 may include hardware and software components for implementing methods the UE 106 to perform cellular communication using a power efficient downlink control information framework. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform cellular communication using a power efficient downlink control information framework according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g. LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

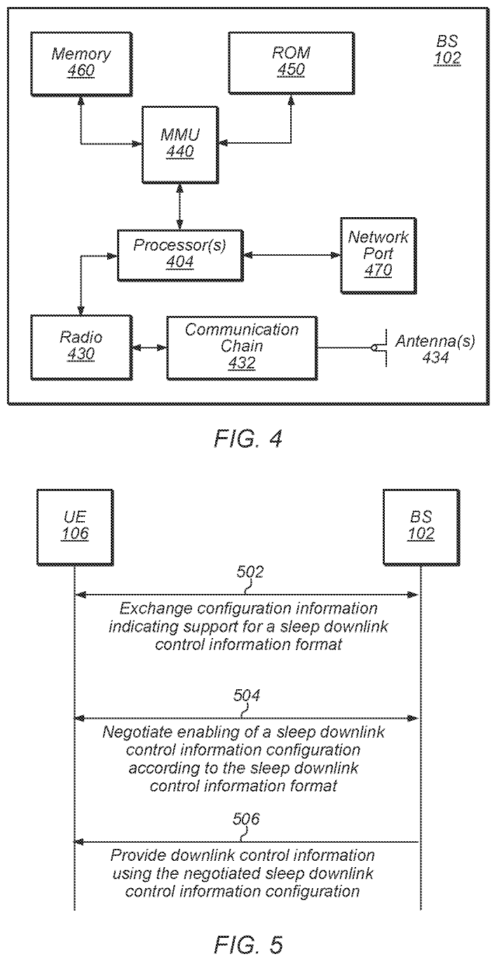

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g. it may include at least one Ethernet port, and radio 430 may be designed to communicate according to the Wi-Fi standard. The base station 102 may operate according to the various methods as disclosed herein for performing cellular communication using a power efficient downlink control information framework.

### FIG. 5—Power Efficient Downlink Control Information Framework for Cellular Communication

FIG. 5 is a communication flow diagram illustrating a method for wireless devices (e.g., a cellular base station and a wireless user equipment (UE) device, as shown, as one possibility) to perform cellular communication using a power efficient downlink control information framework, according to some embodiments.

Aspects of the method of FIG. 5 may be implemented by a wireless device and a cellular base station, such as a UE 106 and a BS 102 illustrated in and described with respect to various of the Figures herein, or more generally in conjunction with any of the computer systems or devices shown in the above Figures, among other devices, as desired. Note that while at least some elements of the method of FIG. 5 are described in a manner relating to the use of communication techniques and/or features associated with LTE, LTE-A, and/or 3GPP specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, the UE 106 and the BS 102 may exchange configuration information indicating support for a sleep downlink control information (sDCI) format. For example, the BS 102 may provide information indicating a software version in use by the BS 102, which may imply support for the sDCI format, and the UE 106 may confirm that it also supports the sDCI format. Any number of additional or alternative exchanges (e.g., including unidirectional exchanges, exchanges involving more than two messages, exchanges including explicit indications, etc.) to indicate support for the sDCI format are also possible.

In 504, the UE 106 and the BS 102 may negotiate enabling of an sDCI configuration according to the sDCI format. The sDCI configuration negotiation may be initiated by the UE 106 or by the BS 102. For example, as one possibility, the UE 106 may send an sDCI enable request that suggests a set of parameters for the sDCI configuration, which the BS 102 may accept or overwrite with a different set of parameters. As another possibility, the BS 102 may send an sDCI enable request that suggests a set of parameters for the sDCI configuration, which the UE 106 may accept. Other negotiation frameworks are also possible.

At least in some instances, it may also be possible for the UE 106 or the BS 102 to reject an sDCI enable request, for any of a variety of possible reasons. For example, the BS 102 and/or the UE 106 may determine whether channel conditions between the cellular base station and the wireless device are sufficient to support use of the sDCI format, and may reject an sDCI enable request if channel conditions are not considered sufficient to support use of the sDCI format. Determining whether the channel conditions are sufficient may be based on any of various considerations, such as one or more measurements performed by the UE 106 and/or the BS 102. For example, a signal to noise ratio (SNR) may be considered (e.g., it may be determined whether the SNR is above or below a specified threshold), Doppler shift may be considered (e.g., it may be determined whether the Doppler shift is above or below a specified threshold), and/or any of various other characteristics of a communication channel between the UE 106 and the BS 102.

Similarly, channel conditions may additionally or alternatively be considered when initially determining whether to propose enabling of an sDCI configuration. For example, at least according to some embodiments, the UE 106 and/or the BS 102 may propose enabling of an sDCI configuration based at least in part on determining that channel conditions are sufficient to support the sDCI configuration, and/or may refrain from proposing enabling of an sDCI configuration based at least in part on determining that channel conditions are not sufficient to support the sDCI configuration.

Note additionally that if desired, a power state of the wireless device may also or alternatively be considered when determining whether to attempt to negotiate use of an sDCI configuration. For example, if the UE 106 is in a power limited state, the UE 106 might be more likely to attempt to negotiate use of an sDCI configuration, e.g., since use of an sDCI configuration may allow for more power efficient operation of the UE 106, at least in some instances.

The sDCI format may include features that can support more efficient downlink control information scheduling based on an application type and/or traffic pattern currently associated with cellular communication between the UE 106 and the BS 102, at least according to some embodiments. For example, one or more parameters of the negotiated sDCI configuration may be selected based at least in part on an application type currently associated with cellular communication between the UE 106 and the BS 102. As one such possibility, an average inter-grant distance (e.g., for uplink and/or downlink grants) for the application type currently associated with cellular communication between the UE 106 and the BS 102 may be considered, e.g., when selecting one or more configuration parameters that affect how often downlink control information is provided and thus potentially how often and for how long the UE 106 may be able to operate in a reduced power mode while still in a radio resource control (RRC) connected state. Selection of such parameters based at least in part on the application type(s) currently associated with cellular communication between the UE 106 and the BS 102 may reduce any potential impact on throughput and/or delay experienced as a result of enabling the sDCI configuration, e.g., if the parameters of the sDCI configuration correspond at least somewhat closely with a typical traffic pattern of the currently active application type(s).

In some instances, at least one sDCI configuration parameter of the selected sDCI configuration may include an sDCI operation mode parameter. The sDCI operation mode parameter may indicate which of multiple possible sDCI operation modes are selected for use, for example from a periodic mode, a dynamic mode, or a hybrid periodic-dynamic mode, among various possibilities.

In the periodic mode, the sDCI configuration may include an sDCI configuration parameter indicating a control channel (e.g, PDCCH) monitoring duty cycle (e.g., a periodicity parameter), according to some embodiments. In the dynamic mode, the sDCI configuration may include an sDCI configuration parameter indicating a sleep duration anchor point, according to some embodiments. In the hybrid periodic-dynamic mode, the sDCI configuration may include an sDCI configuration parameter that serves as both a periodicity parameter and a sleep duration anchor point, according to some embodiments.

In the periodic and/or hybrid mode, it may be possible for the UE 106 to infer from the sDCI configuration parameters and possibly based on whether any downlink control information was received in a given subframe that no downlink control information will be provided to the UE 106 for a certain number of subframes. Similarly, in the dynamic and/or hybrid mode, it may be possible for the BS 102 to dynamically indicate a number of subsequent subframes for which no downlink control information will be provided to the UE 106 with each downlink control information transmission. At least in some instances, it may be possible to provide such an indication using a redundancy version field of a given downlink control information transmission conditionally, for example if the UE 106 and the BS 102 pre-agree on a certain redundancy version to use for new transmissions. One example of the condition to use the redundancy version field is that the current grant is an initial grant or new grant. Thus, this may allow the UE 106 to operate in a reduced power mode (e.g., if no other activities are scheduled) while still in a RRC connected state.

In 506, the BS 102 may provide downlink control information to the UE 106 using the negotiated sDCI configuration. This may include selectively providing downlink control information only in certain subframes that may be determined by both the UE 106 and the BS 102 based on the sDCI configuration.

Note that, at least according to some embodiments, the uplink activities of the UE 106 may be unaffected by the sDCI configuration. For example, it may be possible for the UE 106 to perform an uplink transmission (e.g., a data communication on a physical uplink shared channel that is performed in response to a grant provided by the downlink control information, a control communication such as a scheduling request or buffer status report, etc.) during a subframe for which the UE 106 has determined that no downlink control information will be provided to the UE 106.

Further, in some instances the UE 106 and the BS 102 may revise their determination of in which subframes downlink control information may be provided based at least in part on such uplink control communications by the UE 106. For example, if the UE 106 provides a scheduling request or a buffer status report (e.g., indicating a non-empty buffer) to the BS 102 during a block of subframes for which it was previously determined that no downlink control information will be provided to the UE 106, both the UE 106 and the BS 102 may determine that it is no longer true that no downlink control information will be provided to the UE 106 in (e.g., at least a portion of) those subframes. Similarly, if the UE 106 provides a scheduling request or a buffer status report (e.g., indicating a non-empty buffer) to the BS 102 within a certain amount of time prior to a block of subframes for which the sDCI configuration indicates that no downlink control information will be provided to the UE 106, it may be the case that both the UE 106 and the BS 102 determine that it is no longer true that no downlink control information will be provided to the UE 106 in (e.g., at least a portion of) those subframes. Such techniques may allow for the BS 102 to more promptly respond to the scheduling request or buffer status report, potentially including during a subframe that was indicated to be a subframe in which no downlink control information would be provided to the UE 106 based on the sDCI configuration.

Note that at least in some instances, at least one sDCI configuration parameter of the selected sDCI configuration may include a duration for which the sDCI configuration is enabled. In such a case, the BS 102 and the UE 106 may utilize the negotiated sDCI configuration until expiration of the sDCI configuration, after which they may revert to a default downlink control information configuration (e.g., in which the BS 102 can provide downlink control information in any subframe and thus in which the UE 106 monitors the control channel in every subframe, as one possibility). Alternatively, the BS 102 and the UE 106 may renegotiate to extend the duration for which the sDCI configuration is enabled before expiration or upon expiration of the sDCI configuration, or to enable a different sDCI configuration according to the sDCI format, as desired.

Additionally, note that at least in some instances it may be possible to terminate use of a negotiated sDCI configuration prior to the configured duration of the sDCI configuration. For example, either the BS 102 or the UE 106 may send a request to terminate use of the sDCI configuration early, for any of various possible reasons, and/or the sDCI configuration may be terminated early without additional signaling, for any of various possible reasons. Some non-limiting examples of reasons why use of an sDCI configuration might be terminated early could include channel conditions deteriorating (e.g., as determined based on one or more metrics indicative of channel conditions falling below one or more predetermined thresholds), a handover to a new cell occurring, a change in traffic pattern or an application type currently associated with cellular communication between the cellular base station and the wireless device, RRC reconfiguration or reestablishment activity, or a RRC connection release.

Note still further that, if desired, it may be possible for the UE 106 and/or the BS 102 to implement one or more possible error handling or mitigating techniques in conjunction with an sDCI configuration.

For example, upon enabling the sDCI configuration, the UE 106 may monitor the control channel for a certain number of subframes (e.g., an initial detection period) for which the UE 106 determined that no downlink control information would be provided, e.g., to determine whether the BS 102 is honoring the agreed upon sDCI configuration. If any downlink control information is detected during such a period, the UE 106 may choose not to follow the sDCI configuration, for example instead continuing to monitor the control channel even during subframes in which no downlink control information would have been expected according to the sDCI configuration.

As another example, a monitoring period may be used by the UE 106 in which it is determined whether the BS 102 provides any downlink control information initial transmissions having a redundancy version other than 0, prior to enabling an sDCI configuration, e.g., if the sDCI framework requires that initial transmissions have a redundancy version of 0 to be able to effectively support provision of sleep downlink control information.

As yet another example, in some instances, the BS 102 may be able to detect a discontinuous transmission in response to downlink control information provided while an sDCI configuration is enabled. For example, the UE 106 may not provide an ACK/NACK when expected by the BS 102, e.g., due to mis-alignment in an sDCI session. In such a case, the BS 102 may provide a downlink control information retransmission indicating not to sleep to the UE 106, e.g., in a subframe in which the BS 102 expects that the UE 106 will be monitoring the control channel (e.g., after any subframes that the BS 102 suspects that the UE 106 may be sleeping due to the sDCI configuration). This may help the UE 106 and the BS 102 to re-gain alignment in the sDCI session. Similarly, if a NACK is detected by the BS 102 in response to downlink control information provided while an sDCI configuration is enabled, the BS 102 may provide a downlink control information retransmission indicating not to sleep to the UE 106, e.g., after any remaining control channel blanking duration based on the sDCI configuration between the BS 102 and the UE 106.

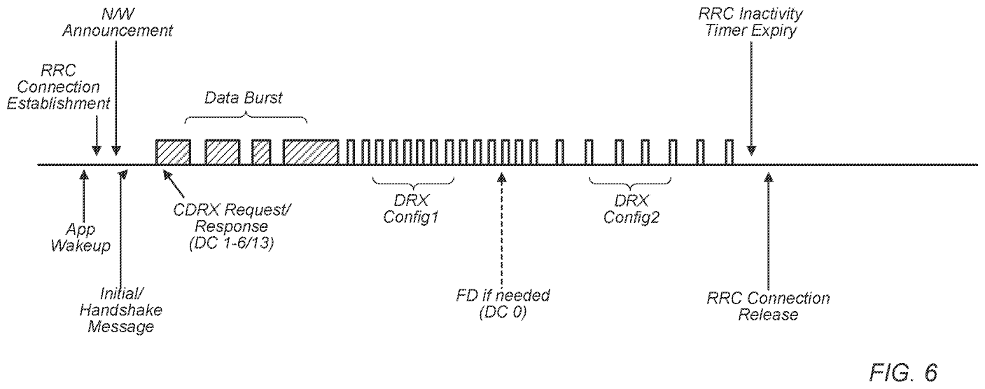

### FIGS. 6-30—Additional Information

FIGS. 6-30 and the following information are provided as being illustrative of further considerations and possible implementation details relating to the method of FIG. 5, and are not intended to be limiting to the disclosure as a whole. Numerous variations and alternatives to the details provided herein below are possible and should be considered within the scope of the disclosure.

FIG. 6 illustrates an exemplary possible cellular communication timeline including a framework for enabling application specific communication features, according to some embodiments. As shown, according to some embodiments, after an application executing on a wireless device wakes up or otherwise becomes active, an RRC connection of a cellular link between the wireless device and a cellular network (e.g., via a cellular base station) may be established (e.g., to serve the communication needs of that application). In the illustrated example scenario, the cellular network may announce (e.g., in a system information block or in any other desired manner) that it supports application-specific features (which may also be referred to as application aware capability, according to some embodiments). The wireless device may provide an initial message indicating feature type information for an application specific feature that it would like to enable. The network may respond to the initial message with a handshake message, e.g., to confirm or reject the requested feature, to accept or modify proposed parameters of the requested feature, and/or otherwise to complete negotiation of use (or non-use) of the requested feature. The wireless device and the network may communicate, potentially using any enabled application specific features, potentially including communicating data in one or more data bursts, operating in one or more connected-mode discontinuous reception configurations, and eventually releasing the RRC connection, e.g., after an RRC inactivity timer for the RRC connection expires.

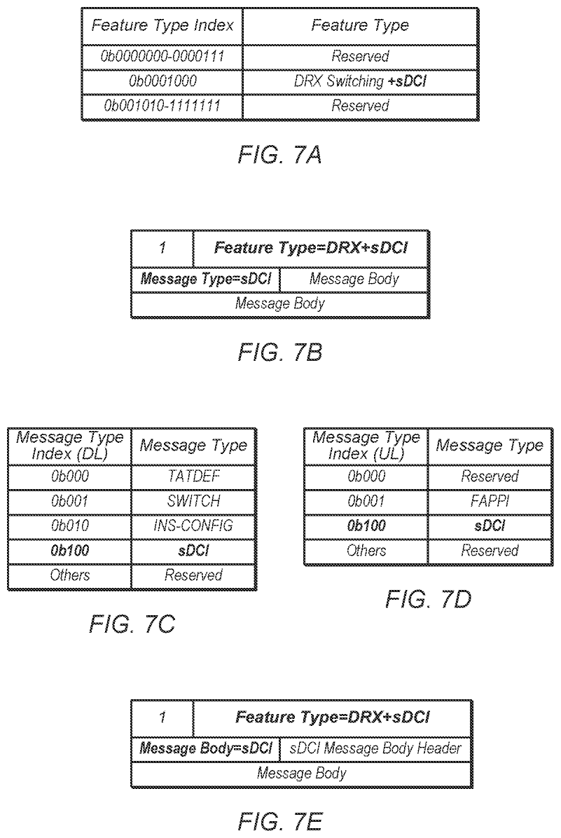

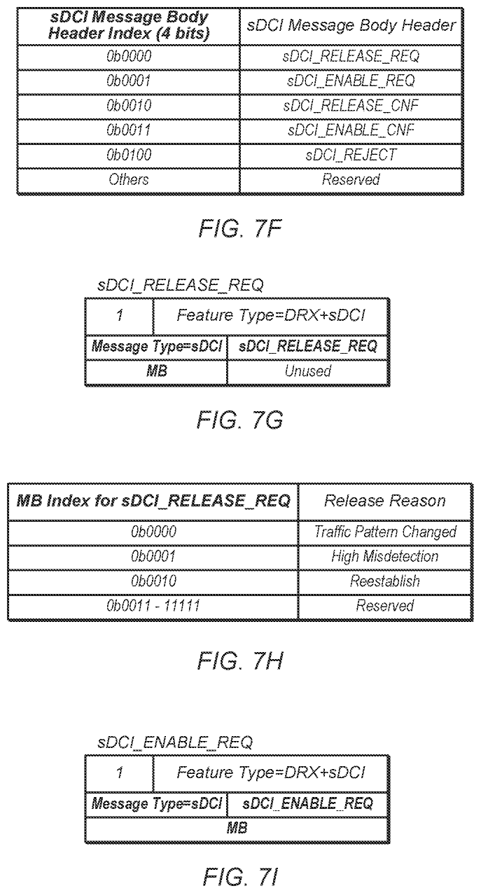

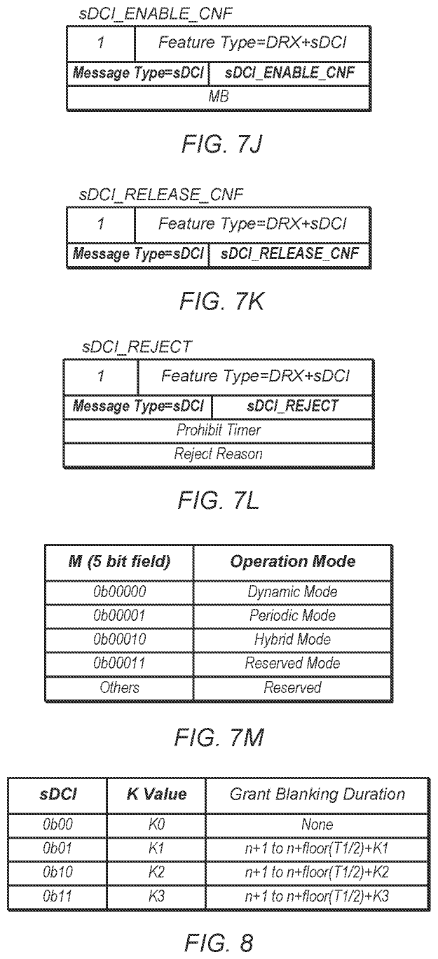

One possible application specific feature that could be enabled using such a framework may include use of a downlink control information framework according to which application type is considered when determining configuration parameters for a downlink control information configuration. Such a downlink control information framework may improve power efficiency at a wireless device, according to some embodiments, for example by facilitating the ability of the wireless device to operate in a reduced power mode more frequently than according to at least some other downlink control information frameworks, potentially with minimal or no impact to user experience. FIGS. 7A-7M illustrate various possible aspects of a message framework for negotiating use of such a power efficient downlink control information framework for cellular communication, according to some embodiments.

At least in some instances, such a power efficient downlink control information framework for cellular communication may be referred to as a sleep downlink control information (sDCI) framework. As one possibility, a feature type index indicating that a feature request message relates to use of the sDCI framework may be multiplexed onto the same feature type index as may also be used for one or more other features, such as a DRX switching feature, as shown in FIG. 7A. Note that such features may be turned on/off independently even if they share a feature type index, e.g., as feature support may be indicated using a software version indicator or in any of various other possible ways, and one or more additional fields of the feature request message may be used to further specify which feature a feature request message relates to. For example, FIG. 7B illustrates that a possible feature request message having a feature type of DRX+sDCI may further include a message type field, which may include an index value indicating that the feature request message relates to the sDCI feature. FIGS. 7C and 7D illustrate exemplary possible message type index values and possible meanings for those message type index values, for downlink and uplink feature request messages respectively, that may be used as one possibility, if desired. Thus, such a message may be used bi-directionally, e.g., such that both the network and the wireless device may be able to use the same feature request message format (though interpretation/priority may differ depending on direction). Note that alternatively, it may be possible that only a wireless device is configured to initiate sDCI service (or vice versa), if desired.

Such a feature request message may be used to request a specific sDCI configuration, confirm a specific sDCI configuration, request deactivation of sDCI, confirm deactivation of sDCI, or reject an sDCI request, among various possibilities. Accordingly, in order to further specify the desired use of an sDCI feature request message, an sDCI message body header field may be defined, such as illustrated in FIG. 7E. Such a field may include (e.g., be provided using) the first 4 bits of the message body of an sDCI feature request message, as one possibility. FIG. 7F illustrates various possible sDCI message body header index values and associated possible meanings, according to some embodiments. At least in some instances, it may be the case that only one message for sDCI is transmitted in each MAC CE.

FIG. 7G illustrates a possible sDCI feature request message that may be used to indicate a request to release an sDCI configuration. As shown, in this case, the sDCI message body header field may include an index value selected to indicate that the sDCI feature request message is a request to release an sDCI configuration, and may further include a message body (MB) field. FIG. 7H illustrates possible message body index values for such a request to release an sDCI configuration, which may relate to possible reasons for requesting release of the sDCI configuration, at least according to some embodiments.

FIG. 7I illustrates a possible sDCI feature request message that may be used to indicate a request to enable an sDCI configuration. As shown, in this case, the sDCI message body header field may include an index value selected to indicate that the sDCI feature request message is a request to enable an sDCI configuration, and may further include a message body field. According to some embodiments, the message body may include a proposed sDCI configuration. For example, one possible configuration format may include 48 bits and including fields for M (4 bits), T0 (16 bits), T1 (8 bits), T2 (4 bits), T3 (4 bits), and {K1, K2, K3} (4 bits each), which may be described in further detail subsequently herein. Other quantities, types, and/or lengths of fields may alternatively be used, as desired. Alternatively, an index to select a configuration from a predetermined set of configurations may be used if desired. In such a case, an additional MAC CE may be used to signal the possible configurations, or a set of configurations may be pre-agreed upon (e.g., standardized).

FIG. 7J illustrates a possible sDCI feature request message that may be used by a wireless device or base station to indicate confirmation of a request by the other party to enable an sDCI configuration. As shown, in this case, the sDCI message body header field may include an index value selected to indicate that the sDCI feature request message is a confirmation of a request to enable an sDCI configuration, and may further include a message body field. According to some embodiments, the message body may follow the same structure as a request to enable an sDCI configuration. At least in some instances, if a base station is providing the confirmation, the base station may include an sDCI configuration that may be the same as the proposed sDCI configuration or may be a modified configuration (e.g., may overwrite the wireless device's request), while if a wireless device is providing the confirmation, the wireless device may echo the base station's proposed sDCI configuration or may leave the message body field blank.

FIG. 7K illustrates a possible sDCI feature request message that may be used by a wireless device or base station to indicate confirmation of a request by the other party to release an sDCI configuration. As shown, in this case, the sDCI message body header field may include an index value selected to indicate that the sDCI feature request message is a confirmation of a request to release an sDCI configuration. In this case, the message body field may be left blank, at least according to some embodiments.

FIG. 7L illustrates a possible sDCI feature request message that may be used by a wireless device or base station to indicate rejection of a request by the other party to enable an sDCI configuration. As shown, in this case, the sDCI message body header field may include an index value selected to indicate that the sDCI feature request message is a rejection of a request to enable an sDCI configuration, and may further include a message body field. As shown, the message body field may include a prohibit timer value (e.g., including 8 bits), which may indicate an amount of time (e.g., in any desired units, such as milliseconds, subframes, slots, etc.) following reception of the rejection for which no sDCI request should be sent, and a rejection reason (e.g., including 4 bits). The rejection reason could include any of various possible reasons, such as channel conditions being judged insufficient to support the sDCI feature, an expectation by the wireless device or the base station of relatively frequent upcoming uplink/downlink communication, or any of various possible other reasons.

As previously noted, at least in some instances, an sDCI enable request and/or an sDCI enable confirm message may include sDCI configuration parameters, which may include any of various possible parameters and may be indicated using any desired number and length of fields. In an example provided previously herein, these parameters may include M, T0, T1, T2, T3, K1, K2, and K3. The M parameter may be used to indicate a proposed sDCI operation mode, according to some embodiments. FIG. 7M illustrates various possible index values and associated meanings for such a field. As shown, according to the illustrated example, the possible operational modes may include a dynamic mode, a periodic mode, and/or a hybrid mode. One or more values may also be reserved for additional modes and/or other information, if desired.

The TO parameter may be used to indicate a length of the proposed sDCI session. For example, the TO parameter may be a value that directly indicates a number of subframes for which the sDCI session will last from a specified or implied start subframe (e.g., subframe n+2 relative to a subframe n in which an sDCI confirm message is received, to account for PDSCH decoding delay, as one possibility).

The T1 parameter may be used to indicate different things depending on the indicated operation mode. For example, in the periodic mode, T1 may be used to indicate a control channel monitoring duty cycle (e.g., a wireless device may be expected to monitor the control channel every T1 subframes and may not be expected to monitor the control channel during the remainder of the subframes of the sDCI session if no grant is received. In the dynamic mode, T1 may be used to indicate a sleep duration anchor point, which may be used to scale possible inter-grant distances that can be dynamically indicated. In the hybrid mode, T1 may be used to indicate a value that may serve as both a duty cycle and an anchor point, according to some embodiments.

The T2 parameter may be used, e.g., in the periodic and hybrid modes, to indicate a conditional timer value, e.g., such that a wireless device may be expected to monitor an additional T2 subframes if (e.g., new or retransmitted) downlink control information is detected in a given subframe.

The T3 parameter may be used, e.g., in the periodic and hybrid modes, to indicate an onDuration timer for each T1 cycle, e.g., such that a wireless device may be expected to monitor the first T3 subframes of each T1 cycle.

The K1, K2, and K3 parameters may be used, e.g., in conjunction with the T1 parameter, to scale possible inter-grant distances that can be dynamically indicated, in the dynamic and hybrid modes. For example, in the dynamic and hybrid modes, it may be possible for a base station to indicate a value Kᵢ (e.g., one of K0, K1, K2, or K3) when providing downlink control information to a wireless device at a subframe n, which may indicate to the wireless device that it is not expected to monitor the control channel for further downlink control information during n+1 to n+floor(T1/2)+Kᵢ, for the values defined for K1, K2, or K3, or to indicate to the wireless device that it is expected to continue monitoring the control channel, for K0.

While the values of K1, K2, and K3 to be used in a given sDCI session may be defined as part of negotiating an sDCI configuration for the sDCI session, it may also be important to provide a way of signaling which of {K0, K1, K2, K3} is actually indicated with each downlink control information transmission. As one possibility, the redundancy version (RV) field of a downlink control information format may be used to indicate the K value for a given DCI transmission when an sDCI session is active, at least for initial DCI transmissions. In such a case, the redundancy version for each initial DCI transmission may be pre-agreed (e.g., to be RV0 or another specified RV), such that the RV field may be leveraged to provide the sDCI K value. This may avoid the need to provide additional control channel (e.g., PDCCH) resources from the network for such signaling. Additionally, since the first transmission block error rate may often be controlled within a certain threshold (e.g., 10%), it may be the case that most DCI transmissions may be new transmissions. FIG. 8 is a table illustrating that a 2 bit field such as the RV field could be used to indicate the K value for a given sDCI transmission. However, note also that other signaling options may also or alternatively be used, including but not limited to using a new transmission with transport block size of 0 as an sDCI trigger, redefining a new DCI format that may provide more flexibility, and/or using zero padding bits, if available.

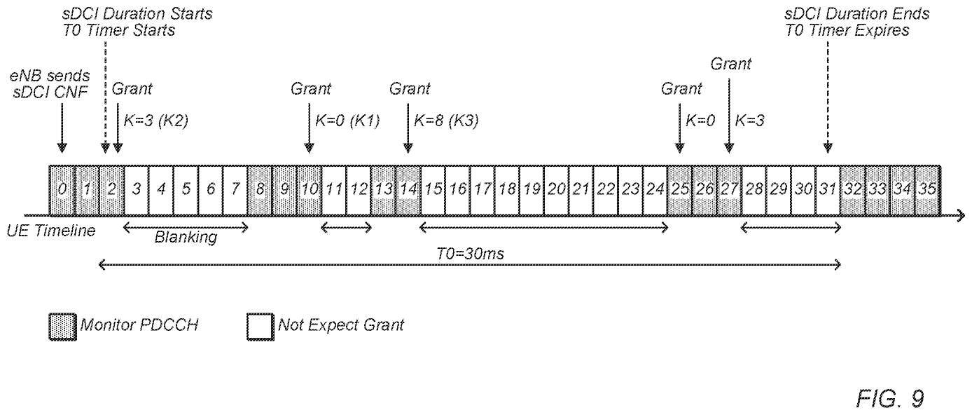

FIG. 9 illustrates an example timeline according to which a wireless device may be able to determine certain subframes to monitor the PDCCH and certain subframes in which no grant is expected according to a dynamic mode sDCI configuration. In the illustrated example, T0=30, T1=5, {K1=0, K2=3, K3=8}, and T2 and T3 are unused. During the sDCI session, each initial DCI grant may use the RV field for the sDCI K value. Based on these K values, the wireless device may be able to determine a certain number of subframes that the base station is dynamically blanking with respect to downlink control information (i.e., that the base station is indicating that it will not use to transmit grant information to the wireless device). After the sDCI session ends, the wireless device may resume a default control channel monitoring configuration.

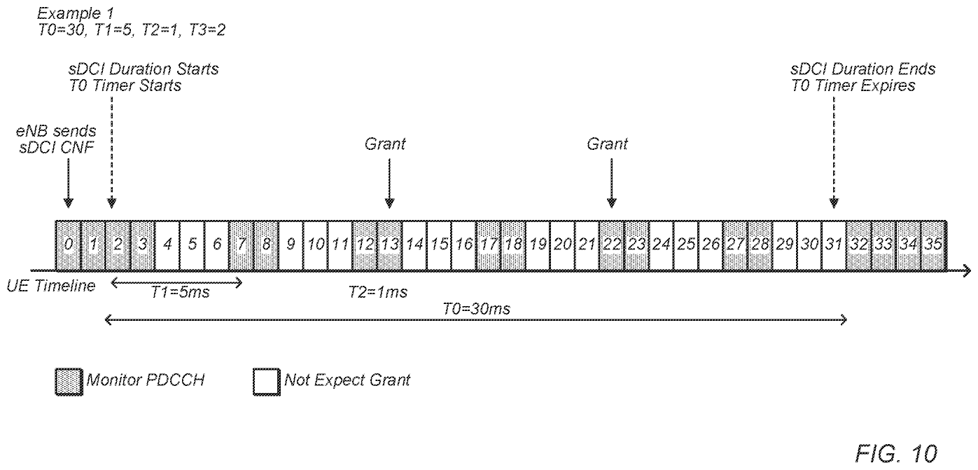

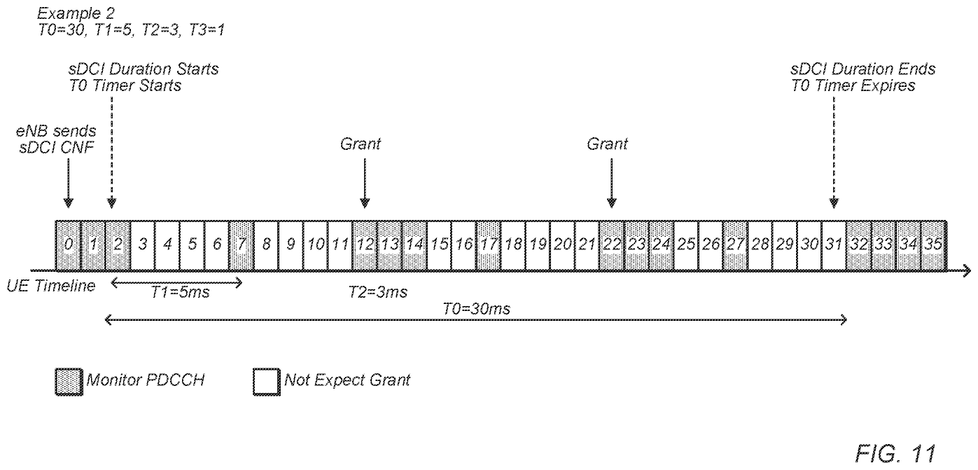

FIGS. 10-11 illustrate example timelines according to which a wireless device may be able to determine certain subframes to monitor the PDCCH and certain subframes in which no grant is expected according to periodic mode sDCI configurations. In the first illustrated example, T0=30, T1=5, T2=1, and T3=2. In the second illustrated example, T0=30, T1=5, T2=3, and T3=1. According to some embodiments, the periodic mode may operate similarly to a 5G NR PDCCH monitoring framework. In both examples, similar to the dynamic mode, after the sDCI session ends, the wireless device may resume a default control channel monitoring configuration.

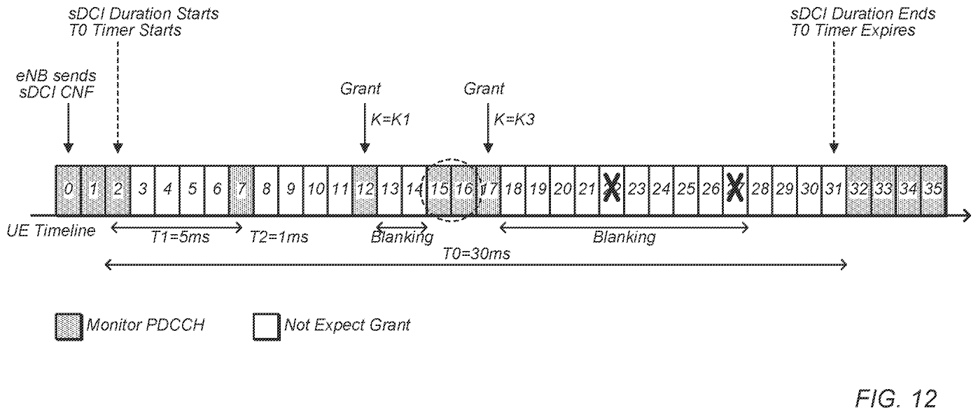

FIG. 12 illustrates an example timeline according to which a wireless device may be able to determine certain subframes to monitor the PDCCH and certain subframes in which no grant is expected according to a hybrid mode sDCI configuration. In the illustrated example, T0=30, T1=5, T2=1, T3=1, and {K1=0, K2=3, K3=8}. Note that in a hybrid mode, the decision of whether a grant may be expected or is not expected in a given subframe may conflict between the sDCI dynamically signaled by the base station and the underlying periodic mode configuration. Such a conflict may be resolved in any of various ways, according to various embodiments. As one possibility, the dynamic mode signaling may be considered to take priority, e.g., as it may be considered to be configured based on more recent information from the base station. In such a case, subframes indicated to be blanked according to dynamic signaling may be considered fully blanked even if DCI might be expected according to the periodic configuration, such as illustrated in subframes 22 and 27 illustrated in FIG. 12. As another possibility, dynamic mode signaling may be considered to take priority until the nearest PDCCH monitoring cycle that covers the blanking duration (e.g., the wireless device may wake up to potentially receive grants more conservatively).

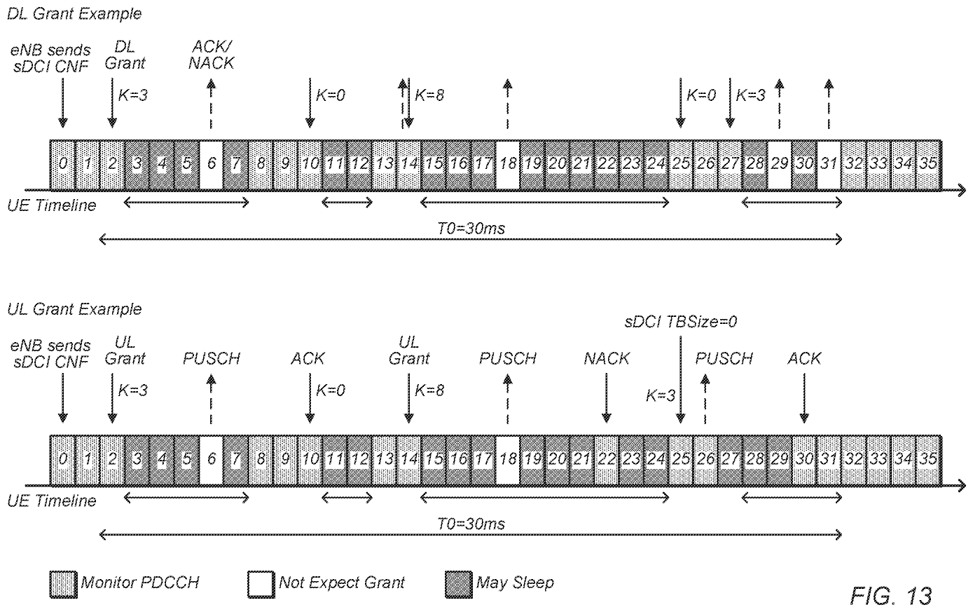

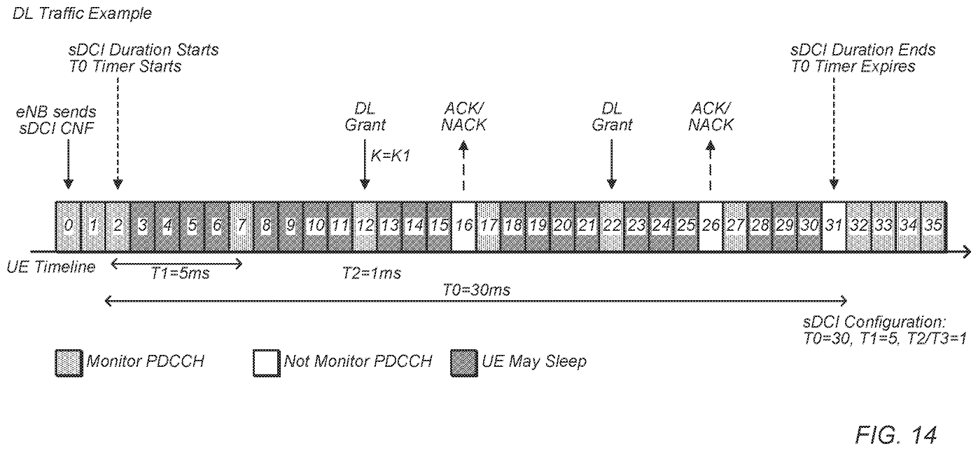

FIGS. 13-14 illustrate example timelines according to which a wireless device may be able to determine certain subframes to monitor the PDCCH and certain subframes in which no grant is expected, and further illustrating the possible sleep schedule impact on the wireless device according to the example timelines.

FIG. 13 illustrates dynamic mode timelines (with T0=30, T1=5, {K1=−2, K2=0, K3=5}, T2/T3 unused) in which downlink grants are provided and in which uplink grants are provided to the wireless device. In many of the subframes for which the wireless device is able to determine that no grant is expected, the wireless device may be able to sleep (e.g., operate in a reduced power mode). However, the wireless device may still follow acknowledgement/negative acknowledgement (ACK/NACK) and uplink hybrid automatic repeat request (HARQ) timelines, such that the wireless device may also remain awake in some subframes for which the wireless device is able to determine that no grant is expected. For example, for downlink, ACK/NACK, channel quality indicator (CQI) reports, sounding reference signals (SRS), and other such signaling may be expected to occur according to their respective expected timelines regardless of whether a grant is expected in a given subframe. Similarly, for uplink, physical HARQ indicator channel (PHICH) and HARQ monitoring may occur during subframes for which no grant is expected according to an sDCI configuration, in some instances.

FIG. 14 illustrates a periodic mode timeline (with T0=30, T1=5, T2/T3=1). Similar to FIG. 13, in many of the subframes for which the wireless device is able to determine that no grant is expected, the wireless device may be able to sleep. Also similar to FIG. 13, the wireless device may still follow ACK/NACK and uplink HARQ timelines, such that the wireless device may also remain awake in some subframes for which the wireless device is able to determine that no grant is expected.

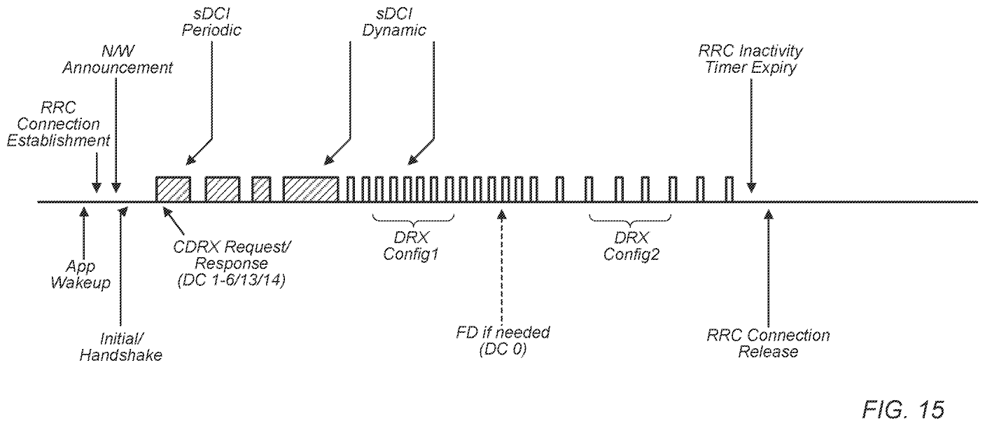

FIG. 15 illustrates an exemplary possible cellular communication timeline including a framework for enabling application specific communication features, in which sDCI features are used, according to some embodiments. In this case, after a network announcement that application-specific features, including sDCI, are supported, a wireless device and the network may negotiate an sDCI periodic session, and data may be communicated in accordance with the sDCI periodic session, as shown. Later in the example timeline, one or more sDCI dynamic sessions may further be negotiated, and data may be communicated in accordance with the sDCI dynamic session(s), as shown.

As previously noted herein, at least according to some embodiments, a wireless device or a base station may reject an sDCI enable request, for example based on certain entry conditions for an sDCI session not being met. At least according to some embodiments, a wireless device and/or a base station may similarly determine whether certain entry conditions for an sDCI session are met prior to initially transmitting an sDCI enable request. The entry conditions may include any of various possible conditions, and may be based on channel conditions between the wireless device and the base station, power state of the wireless device, traffic pattern associated with the cellular link between the wireless device and the base station, etc. For example, one entry condition may include SNR being greater than a certain (e.g., predetermined or dynamically indicated/determined) threshold, e.g., to help avoid sDCI misdetection and false alarms. According to some embodiments, a SNR threshold that is expected to produce a low mis-detection probability and/or a low false alarm probability may be selected. Dopper spread/shift may also be considered; for example, if Doppler is above a certain threshold, it may be preferable not to initiate an sDCI session, since channel conditions may commonly be more rapidly changing when Doppler is higher. As another possibility, when the wireless device is in a power-limited condition (e.g., battery reserves are below a threshold and/or a power-limited user option has been selected), the wireless device may be more likely to attempt to initiate an sDCI session, e.g., since such a session may reduce power consumption by the wireless device. As still another possibility, the wireless device and/or the cellular base station may be more likely to attempt to initiate an sDCI session for certain application types and/or traffic patterns than for others.

Additionally, if the entry conditions for attempting to initiate an sDCI session are met, at least in some instances the wireless device may determine a preferred configuration parameter set for the sDCI session, e.g., based on a profile for a site with which the wireless device is communicating, based on an application type actively using the cellular communication link, and/or based on any of various other possible considerations.

At least in some instances, the wireless device and/or the cellular base station may also or alternatively utilize one or more exit conditions to determine whether to release an sDCI session early. Such conditions may cause implicit release of an sDCI session (e.g., without further signaling), or may require further signaling between the wireless device and the cellular base station to request and confirm release of the sDCI session, according to various embodiments. One such possible exit condition may include SNR and/or other channel condition indicators (e.g., downlink and/or uplink block error rate) crossing a predetermined or dynamically signaled threshold (e.g., indicating that channel conditions have worsened). Another possibility may include Dopper rising above a certain threshold (e.g., indicating that wireless device movement has increased). Still other possible exit conditions may include traffic pattern changing, power state changing, handover of the wireless device to a different cell, an out-of-sync event occurring, performing a RRC reconfiguration or reestablishment procedure, or releasing an RRC connection altogether, among various possibilities.

In some instances, it may be possible for a wireless device and a cellular base station to become mis-aligned in an sDCI session, e.g., such that a wireless device is not monitoring the PDCCH when the cellular base station is expecting it to do so, and/or such that the wireless device is monitoring the PDCCH when the cellular base station is not expecting it to do so. The base station may be able to detect such occurrences, at least in some instances, when a discontinuous transmission (DTS or DTX) occurs (e.g., when neither ACK nor NACK is received when expected in response to a transmission). According to some embodiments, when a base station detects such a DTS during an sDCI session, it may attempt to send a grant outside of the maximum expected wireless device sleep duration. This may help re-align the cellular base station and the wireless device. If the number of DTSs that occur exceeds a threshold (e.g., either pre-agreed or base station implemented) during an sDCI session, the base station may trigger sDCI release, e.g., with a reason of “reestablishment” or “high misdetection”. Once an sDCI session is released due to “high misdetection”, a prohibit timer may run at both the wireless device and the base station, during which period it may be the case that neither party requests initiation of an sDCI session. This may help prevent frequent toggling between using sDCI and not using sDCI. The timer length/value could be either signaled (e.g., using a MAC CE) or could be predetermined (e.g., standardized), according to various embodiments.

Since the parameters of an sDCI session (and potentially the signaling used in the dynamic sDCI mode) may be selected based at least in part on an active application type (e.g., may be based on a statistically expected inter-grant distance), in many instances it may be the case that an sDCI feature such as described herein may not cause excess scheduling delays. In particular, if BLER is expected to be relatively low (e.g., <10%), NACKs may be relatively infrequent. Accordingly, as one possibility, the wireless device and the base station may continue to follow the same sDCI timeline as configured even when a downlink NACK occurs, e.g., even in delay sensitive scenarios. However, this may lead to TCP delays or even packet loss, and potential throughput degradation. Thus, as an alternative, e.g., to help mitigate such potential problems in delay sensitive scenarios, upon sending a NACK, in dynamic mode, a wireless device may terminate the sDCI configured by the previous DCI after 4 ms (e.g., if 4 ms is the minimum turnaround time from the base station, as may be the case in at least some implementations). As an alternative, in periodic mode, the UE may monitor the PDCCH for a certain number of subsequent cycles upon sending a NACK.

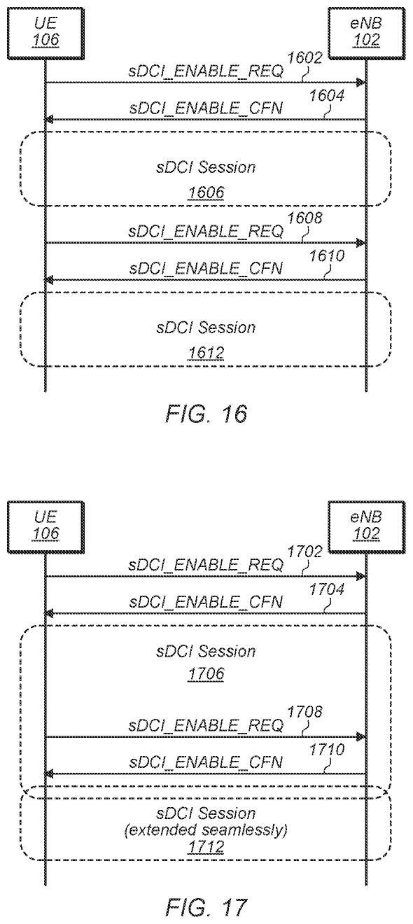

FIGS. 16-21 are communication flow diagrams illustrating various use-cases in which an sDCI feature such as described herein may be enabled in various ways, according to some embodiments. FIG. 16 illustrates a scenario in which a UE 106 sends a request to a eNB 102 to enable an sDCI session (1602). The eNB 102 may confirm enabling of the sDCI session (1604), and the UE 106 and the eNB 102 may communicate according to the configured sDCI session (1606). After expiration of the sDCI session, the UE 106 may send another request to the eNB 102 to enable another sDCI session (1608). The eNB 102 may confirm enabling of the additional sDCI session (1610), and the UE 106 and the eNB 102 may communicate according to the additional sDCI session (1612).

FIG. 17 illustrates a scenario in which a UE 106 sends a request to a eNB 102 to enable an sDCI session (1702). The eNB 102 may confirm enabling of the sDCI session (1704), and the UE 106 and the eNB 102 may communicate according to the configured sDCI session (1706). Prior to expiration of the sDCI session, the UE 106 may send a request to the eNB 102 to extend the sDCI session (1708). The eNB 102 may confirm enabling of the sDCI session extension (1710), and the UE 106 and the eNB 102 may continue to communicate according to the extended sDCI session (1712).

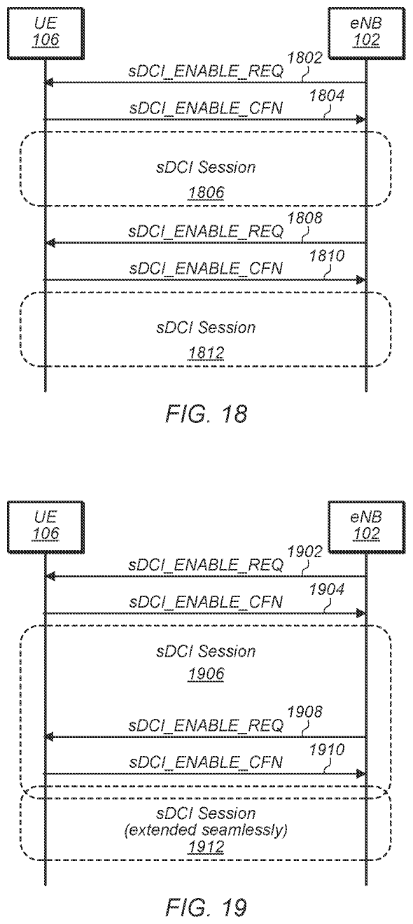

FIG. 18 illustrates a scenario in which a eNB 102 sends a request to a UE 106 to enable an sDCI session (1802). The UE 106 may confirm enabling of the sDCI session (1804), and the UE 106 and the eNB 102 may communicate according to the configured sDCI session (1806). After expiration of the sDCI session, the eNB 102 may send another request to the UE 106 to enable another sDCI session (1808). The UE 106 may confirm enabling of the additional sDCI session (1810), and the UE 106 and the eNB 102 may communicate according to the additional sDCI session (1812).

FIG. 19 illustrates a scenario in which a eNB 102 sends a request to a UE 106 to enable an sDCI session (1902). The UE 106 may confirm enabling of the sDCI session (1904), and the UE 106 and the eNB 102 may communicate according to the configured sDCI session (1906). Prior to expiration of the sDCI session, the eNB 102 may send a request to the UE 106 to extend the sDCI session (1908). The UE 106 may confirm enabling of the sDCI session extension (1910), and the UE 106 and the eNB 102 may continue to communicate according to the extended sDCI session (1912).

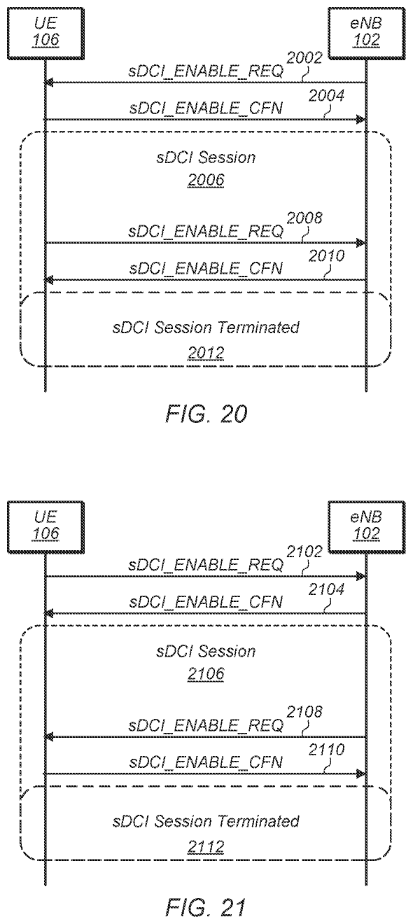

FIG. 20 illustrates a scenario in which a eNB 102 sends a request to a UE 106 to enable an sDCI session (2002). The UE 106 may confirm enabling of the sDCI session (2004), and the UE 106 and the eNB 102 may communicate according to the configured sDCI session (2006). Prior to expiration of the sDCI session, the UE 106 may send a request to the eNB 102 to release the sDCI session (2008). The eNB 102 may confirm release of the sDCI session extension (2010), and the UE 106 and the eNB 102 may terminate the sDCI session (2012).

FIG. 21 illustrates a scenario in which a UE 106 sends a request to a eNB 102 to enable an sDCI session (2102). The eNB 102 may confirm enabling of the sDCI session (2104), and the UE 106 and the eNB 102 may communicate according to the configured sDCI session (2106). Prior to expiration of the sDCI session, the eNB 102 may send a request to the UE 106 to release the sDCI session (2108). The UE 106 may confirm release of the sDCI session extension (2110), and the UE 106 and the eNB 102 may terminate the sDCI session (2112).

It should be noted that while FIGS. 16-21 illustrate a variety of signaling sequences that may be used in a variety of scenarios in conjunction with sDCI sessions, the illustrated set of sequences are not intended to be considered exhaustive, and that numerous other signaling sequences may also or alternatively be used in conjunction with sDCI sessions, as desired.

As previously noted, there may be any number of possible ways to indicate sDCI to a UE. One possibility may include introducing a special DCI format, or content, to a wireless communication standard. As another possibility (e.g., as an alternative technique or to be used until such format/content is standardized), it may be possible to use an invalid or otherwise not currently used DCI format to signal sDCI. Such a technique may provide a low false alarm rate at the UE (e.g., as DCI may be CRC protected), and/or may avoid interfering with normal operation of the DCI (e.g., since the format used for sDCI may be outside of/not used by normal DCI operation).

DCI format 1A (e.g., as defined according to 3GPP specifications) may be used as a fallback DCI format, e.g., which all UEs may be expected to be able to decode. This format may use the RA2 format (e.g., a type 2 resource allocation field), which may rely on a resource indication value (RIV) for resource allocation The RIV may indicate a start RB and duration of contiguous RBs of the resource allocation. At least according to some embodiments, the RIV bit width may be:

$$cei ⌈ {log}_{2} ( \frac{{N}_{RB}^{DL} ( {N}_{RB}^{DL} + 1 )}{2} ) ⌉$$

The total number of valid configurations may be:

$$\frac{{N}_{RB}^{DL} ( {N}_{RB}^{DL} + 1 )}{2}$$

So an RIV value greater than or equal to this value may be a non-valid/not used configuration.

Accordingly, it may be possible for a base station (e.g., gNB) to signal sDCI by transmitting DCI with format 1A, and in the RIV field, transmitting a RIV value that is greater than or equal to:

$$\frac{{N}_{RB}^{DL} ( {N}_{RB}^{DL} + 1 )}{2}$$

The specific value used may be pre-agreed upon between the network and the UE via RRC control signaling, MAC CE signaling, or in any other desired manner, according to various embodiments.

The sleep duration for the sDCI may be encoded in any of a variety of ways. One possibility may include using the redundancy version field, e.g., in a similar manner as previously described herein. For example, RV 00 may be used to indicate a sleep duration ‘x0’ (or ‘K0’) ms, RV 01 may be used to indicate a sleep duration ‘x1’ (or ‘K1’) ms, RV 10 may be used to indicate a sleep duration ‘x2’ (or ‘K2’) ms, and RV 11 may be used to indicate a sleep duration ‘x3’ (or ‘K3’) ms, where the mapping between RV and sleep duration (e.g., the x0/x1/x2/x3 or K0/K1/K2/K3 values) can be signaled to the UE via RRC or MAC CE control signaling.

From the UE perspective, to receive such an sDCI, the UE may decode a DCI with format 1A, and in the RIV field, detect a RIV value greater than or equal to:

$$\frac{{N}_{RB}^{DL} ( {N}_{RB}^{DL} + 1 )}{2}$$

Based on pre-agreement, the UE may recognize that this is for sDCI, and may determine the indicated sleep duration in accordance with the technique used by the base station to indicate the sleep duration. Following the previous example of using the redundancy version field, the UE may determine that a sleep duration ‘x0’ (or ‘K0’) ms is indicated if RV 00 is used, a sleep duration ‘x1’ (or ‘K1’) ms is indicated if RV 01 is used, a sleep duration ‘x2’ (or ‘K2’) ms is indicated if RV 10 is used, or a sleep duration ‘x3’ (or ‘K3’) ms is indicated if RV 11 is used, where the mapping between RV and sleep duration (e.g., the x0/x1/x2/x3 or K0/K1/K2/K3 values) can be signaled to the UE via RRC or MAC CE control signaling.

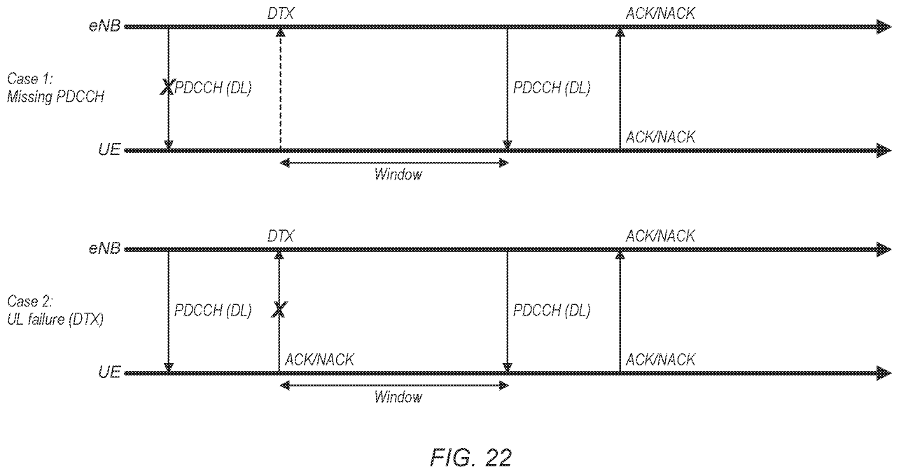

One potentially important aspect of implementing an sDCI scheme may include error/failure detection and handling/recovery. FIG. 22 depicts two possible scenarios in which a base station detects that discontinuous transmission has occurred (e.g., instead of receiving an ACK/NACK when one is expected) in an active sDCI session. In the first scenario, the UE may not receive a transmission on the PDCCH, and so may not send an ACK/NACK at all. In the second scenario, the UE may receive the transmission on the PDCCH, and may send an ACK/NACK, but the base station may not receive the ACK/NACK.

The base station may not be able to determine which scenario has occurred when it detects that discontinuous transmission has occurred. Accordingly, the response may be the same for both scenarios, and may include sending a grant outside (e.g., after) the PDCCH blanking period specified by the previous grant (e.g., to ensure that the UE will be awake for the next grant). In both scenarios, this may not have any delay impact for base station scheduling. For the UE, in the first scenario, this may have a slight power cost (e.g., as the UE may monitor the PDCCH throughout), while in the second scenario, there may be no impact in power (e.g., as the UE is not monitoring the PDCCH during the blanked period).

In the grant provided by the base station after a discontinuous transmission, a new data indicator (NDI) may not be toggled (e.g., indicating a retransmission), and RV0 may be used. This may help avoid confusion for the UE in the second scenario, e.g., as if the base station uses an RV value other than 0, the UE may view the RV as indicating a PDCCH blanking duration, e.g., since the UE may receive the grant as an initial transmission, which may lead to misalignment. Another potential advantage of using RV0 in such a scenario is that it may effectively disable sDCI until the reception or performance is stabilized (e.g., if RV0 is used to indicate a sleep duration of 0 ms). However, it should be noted that using RV0 in the case of a NACK provided by the UE being detected as a discontinuous transmission by the base station, the UE may be limited to use of chase-combining for its HARQ combining, e.g., instead of incremental redundancy (IR).

In some instances, as an additional protection mechanism, if the base station detects a certain number of discontinous transmissions within a certain time window, it may suspend sDCI use for the remainder of the sDCI session, e.g., by always using RV0 in initial transmissions for the remainder of the sDCI session, or by providing a MAC CE indicating to the UE to end the sDCI session.

From the UE perspective, in the case of an ACK provided by the UE being detected as a discontinuous transmission by the base station, the UE may receive duplicated data, and sDCI may effectively be suspended following the second PDCCH transmission. In the case of a NACK provided by the UE being detected as a discontinuous transmission by the base station, the UE may receive a retransmission with the same RV, and sDCI may effectively be suspended following the second PDCCH transmission.

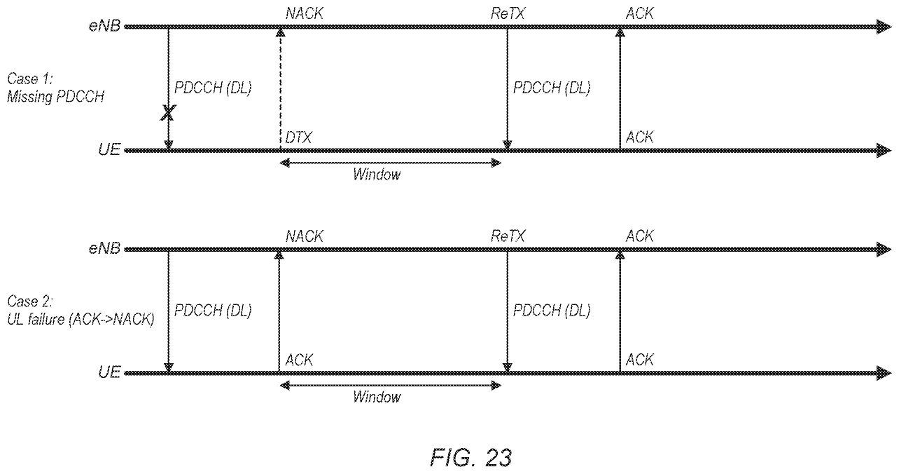

FIG. 23 depicts possible scenarios in which a base station erroneously detects a NACK instead of detecting a DTX actually provided by the UE and in which a base station erroneously detects a NACK instead of receiving an ACK actually provided by the UE in an active sDCI session. At least according to some embodiments, in such scenarios, the base station may follow the PDCCH blanking duration specified by the previous sDCI. In the retransmission, the base station may utilize any RV value as desired. In some instances (e.g., in the first illustrated scenario), this may result in the UE incorrectly interpreting the RV value as an sDCI indicator, as it may view the grant as a new transmission. Such failure may be accepted as a low probability event, at least in some embodiments, e.g., as the probability (probability of missing PDCCH* probability of DTX->NACK) may be relatively tightly controlled by sDCI triggering conditions. Additionally, if used, the additional protection mechanism of suspending sDCI use for the remainder of the sDCI session if the base station detects a certain number of discontinous transmissions within a certain time window may help limit the impact of such error scenarios.

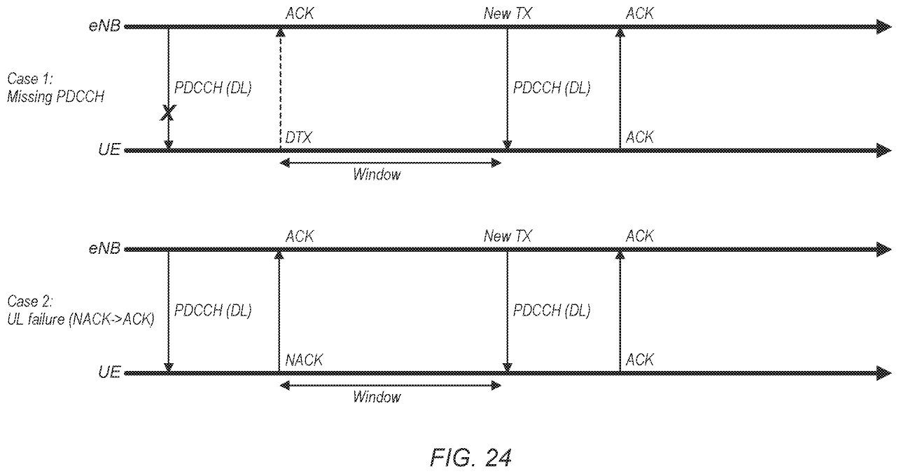

FIG. 24 depicts possible scenarios in which a base station erroneously detects an ACK instead of detecting a DTX actually provided by the UE and in which a base station erroneously detects an ACK instead of receiving a NACK actually provided by the UE in an active sDCI session. At least according to some embodiments, in such scenarios, the base station may follow the PDCCH blanking duration specified by the previous sDCI. In the new transmission, the base station may utilize the RV bit-field as an sDCI indicator. In some instances (e.g., in the second illustrated scenario), the behavior may be the same as in the error case without sDCI, such that no extra cost may be introduced by the sDCI. In some instances (e.g., in the first illustrated scenario), if the same HARQ ID is used and NDI is not-toggled from the UE perspective, the UE may treat it as a retransmission. In this case, the UE may incorrectly interpret the RV in the supposed retransmission, and thus decoding may be unsuccessful, and the UE may send a NACK. Regardless of whether sDCI is in use or not, UE decoding may fail, e.g., as the UE may try to combine it with incorrect TB. Thus, the existing mechanism may effectively also handle this case.

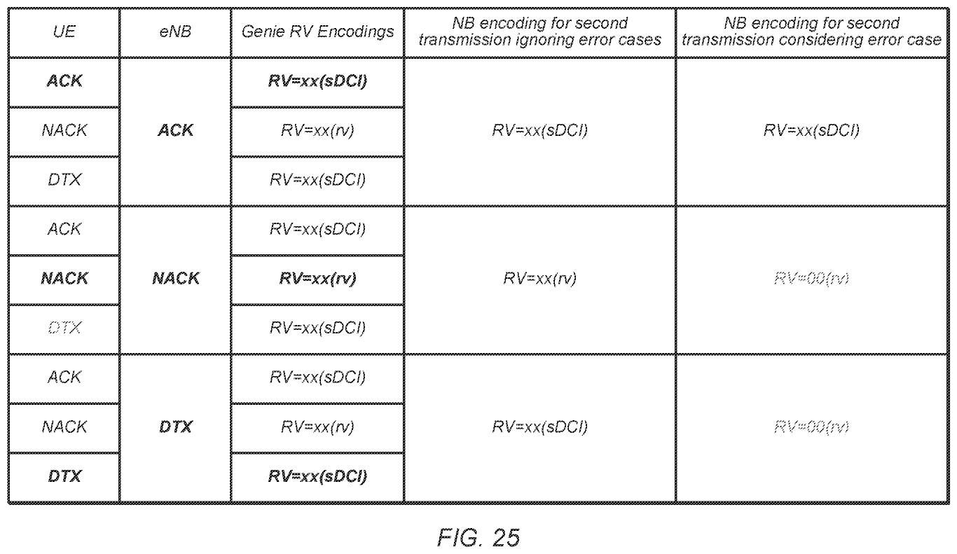

FIG. 25 illustrates possible handling options for a base station with respect to the RV field for a second transmission when considering error cases and when ignoring error cases, according to some embodiments. As shown, a scheme could be designed without considering error cases, e.g., such that it is assumed that no interpretation errors occur in DL/UL (ACKs are always received as ACKs, NACKs are always received as NACKs, and DTX are always interpreted as DTX). But if the chances of such error cases are non-ignorable and/or their impact to system performance is non-ignorable, it may be important to provide robustness against such error cases in the scheme, e.g., and consider one or more of the possibility that an ACK could be interpreted as a NACK or DTX, a NACK could be interpreted as an ACK or DTX, and/or a DTX could be interpreted as an ACK or NACK. If it is possible to increase the robustness without sacrificing system performance, this may generally be beneficial. However, in many instances there may be a trade-off, e.g., in terms of decrease of throughput, increased delay, etc. In sDCI operation such as described herein, one possibility may be to use chase combining only instead of incremental redundancy, at least under some circumstances, to increase robustness (e.g., at the cost of likely throughput loss). Whether to make this tradeoff may depend on how often error cases occur, and/or how much throughput is affected.

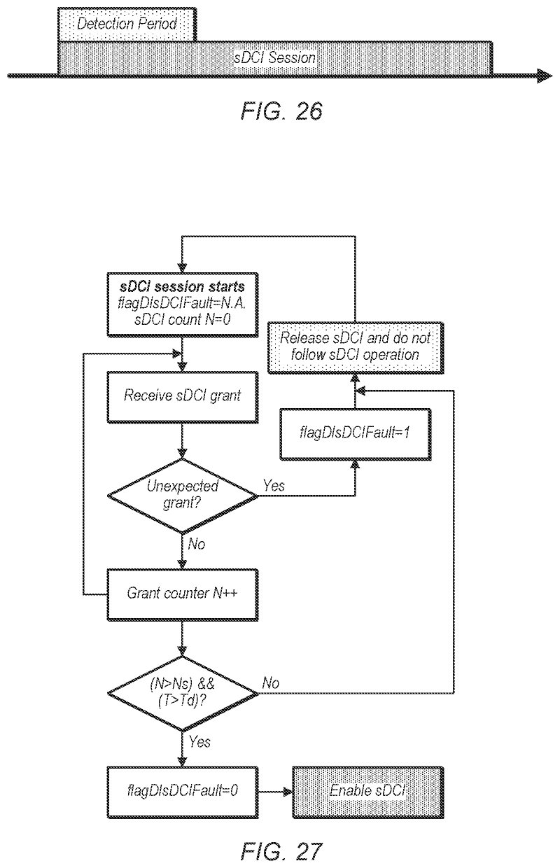

Another possible type of issue that may be helpful to consider and potentially address may include certain fault detection scenarios. For example, in some instances, a base station could configure an sDCI session and send an sDCI indication via RV in an initial transmission, but not honor it. FIGS. 26-27 illustrate aspects of a possible technique for a UE to handle such behavior, according to some embodiments. As shown, the UE may utilize a detection period for an initial portion of an sDCI session. When requesting sDCI, the UE may recommend a certain value (e.g., T1, which may represent an average inter-grant distance) as an anchor point. After the base station confirms the sDCI session, the UE may not follow the sDCI operation immediately, but may instead keep monitoring the PDCCH for both downlink and uplink grants for the detection period (e.g., which may last for a certain specified time-duration such as A*T1, and/or for a certain specified number of grants (Ns)). If, during the detection period, the base station honors the sDCI arrangement, the UE may follow the sDCI configuration for the remainder of sDCI session. If desired, the UE may utilize an internal flag to indicate that the network behaved as expected (e.g., “flagD1sDCIFault”=0). Otherwise, if the base station does not follow the sDCI arrangement during the detection period (e.g., an unexpected grant is received), the UE may continue to not follow sDCI operation and trigger sDCI release. If desired, the UE may utilize an internal flag to indicate that the network did not behaved as expected (e.g., “flagD1sDCIFault”=1). Once such a flag is set, the UE may choose not to request sDCI unless the network has changed (e.g., if the UE camps on equipment provided by a different infrastructure vendor and/or network operator), at least according to some embodiments. If desired, high RLC BLER or missing packet rate can also be used as an indicator of misalignment and to trigger sDCI recovery/release.

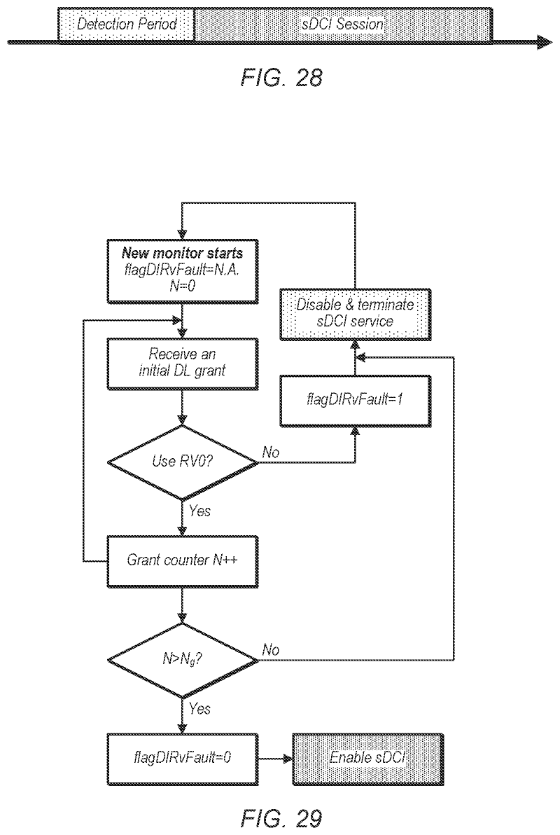

As another example, in some instances, a base station could send an RV other than 0 in an initial transmission, which may render a scheme that is based upon a base station consistently using an RV of 0 for initial transmissions ineffective. FIGS. 28-29 illustrate aspects of a possible technique for a UE to handle such behavior, according to some embodiments. As shown, the UE may utilize a detection period, potentially prior to initiating or agreeing to an sDCI session. For a same NM configuration, the UE may monitor the RV used in initial transmissions for downlink and uplink separately. For each of downlink and uplink, there may be a minimum number of grants (N_{g}) to monitor. If the UE detects DL/UL grants that use a RV other than 0 within N_{g}, then the UE may set a downlink initial RV fault flag (e.g., “flagD1RvFault”=1) and/or uplink initial RV fault flag (e.g., “flagU1RvFault”=1) as true. Otherwise, the UE may set the downlink initial RV fault flag (e.g., “flagD1RvFault”=0) and/or uplink initial RV fault flag (e.g., “flagU1RvFault”=) as false. Once one of these flags is set to 1, the UE may not trigger sDCI server and may terminate any existing sDCI session, at least until a next detection period is triggered and completed. According to some embodiments, such flags can be set to 1 at any time within the same network (e.g., as may be defined in any of various ways, such as per RRC connection, per area/operator linking to a particular infrastructure equipment type, etc.). The implementation may be base station transparent (e.g., the base station may not be aware of the UE implementing such a scheme). If desired, high RLC BLER or missing packet rate can also be used as an indicator of misalignment and to trigger sDCI recovery/release.

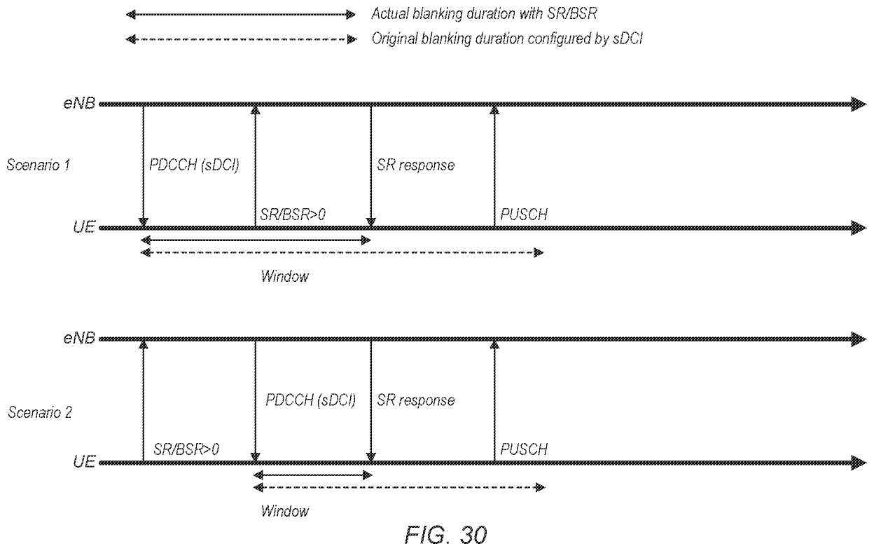

In some instances, it may be desirable for a base station and wireless device to mutually agree that in certain circumstances/scenarios, a PDCCH blanking duration configured using sDCI will be terminated early. For example, if a wireless device has uplink data to transmit (e.g., that the base station did not know about or did not have sufficient time to update its scheduling algorithm based on at the time of providing the sDCI), it may be beneficial for the base station to be able to provide downlink control information and for the wireless device to resume PDCCH monitoring sooner than indicated in accordance with a sDCI transmission. FIG. 30 illustrates multiple such possible scenarios, according to some embodiments.

In a first scenario (e.g., as illustrated in the upper portion of FIG. 30), during a PDCCH blanking period specified by a sDCI transmission, it is possible that a eNB may still receive a scheduling request or buffer status report (e.g., indicating a non-empty buffer) from a UE. In this case, both the eNB and the UE may discard the PDCCH blanking period previously indicated. This may allow the eNB to send a response to the SR/BSR as soon as possible upon receiving the SR/BSR, and for the UE to monitor the PDCCH for the SR/BSR response at an earlier time than would have occurred in accordance with the originally configured PDCCH blanking period. Note that in some instances, a SR/BSR scheduling delay may be configured such that the UE may not immediately resume monitoring the PDCCH after providing a SR/BSR, e.g., to account for a minimum possible turnaround time for the eNB to provide a response to the SR/BSR.

In a second scenario (e.g., as illustrated in the lower portion of FIG. 30), a eNB may receive a scheduling request or buffer status report (e.g., indicating a non-empty buffer) from a UE, and due to a scheduling delay at the eNB, the eNB may still send sDCI. To account for such a scenario, if a UE receives sDCI within a certain configured amount of time of sending a scheduling request or buffer status report indicating a non-empty buffer, both the eNB and the UE may discard the sDCI configuration and the UE may still monitor the PDCCH. This may similarly allow the eNB to send a response to the SR/BSR, and for the UE to monitor the PDCCH for the SR/BSR response, at an earlier time than would have occurred in accordance with the originally configured PDCCH blanking period.

Thus, the techniques illustrated in FIG. 30 may reduce the potential impact on uplink transmission delay and/or throughput of utilizing sleep downlink control information, at least according to some embodiments.

In the following further exemplary embodiments are provided.

One set of embodiments may include a method, comprising: by a cellular base station: exchanging configuration information with a wireless device, wherein the configuration information exchanged indicates that the cellular base station and the wireless device support a sleep downlink control information (sDCI) format; negotiating with the wireless device to enable an sDCI configuration according to the sDCI format, wherein at least one sDCI configuration parameter of the sDCI configuration is selected based at least in part on an application type currently associated with cellular communication between the cellular base station and the wireless device; providing downlink control information to the wireless device during one or more subframes in accordance with the sDCI configuration; and determining one or more subframes for which no downlink control information will be provided to the wireless device based at least in part on the sDCI configuration.

Another set of embodiments may include a method, comprising: by a wireless device: exchanging configuration information with a cellular base station, wherein the configuration information exchanged indicates that the cellular base station and the wireless device support a sleep downlink control information (sDCI) format; negotiating with the cellular base station to enable an sDCI configuration according to the sDCI format, wherein at least one sDCI configuration parameter of the sDCI configuration is selected based at least in part on an application type currently associated with cellular communication between the cellular base station and the wireless device; receiving downlink control information from the cellular base station during one or more subframes in accordance with the sDCI configuration; and determining one or more subframes for which no downlink control information will be provided to the wireless device based at least in part on the sDCI configuration.

According to some embodiments, according to the negotiated sDCI configuration, the cellular base station provides an indication of a number of subsequent subframes for which no downlink control information will be provided to the wireless device with each downlink control information transmission.

According to some embodiments, the indication of the number of subsequent subframes for which no downlink control information will be provided to the wireless device in a respective downlink control information transmission is provided using a redundancy version field of the respective downlink control information transmission.

According to some embodiments, the at least one sDCI configuration parameter comprises an anchor point parameter and a plurality of offset parameters, wherein the indication provided using the redundancy version field comprises an index value associated with an offset parameter selected from the plurality of offset parameters, wherein the method further comprises: determining the number of subsequent subframes for which no downlink control information will be provided to the wireless device based at least in part on the indicated offset parameter and the anchor point parameter.

According to some embodiments, the indication of the number of subsequent subframes for which no downlink control information will be provided to the wireless device in a respective downlink control information transmission is provided by setting a predetermined downlink control information field to a value configured to indicate an sDCI trigger.

According to some embodiments, at least one sDCI configuration parameter of the sDCI configuration comprises an sDCI operation mode, wherein the sDCI operation mode is selected from one or more of: a periodic mode; a dynamic mode; or a hybrid periodic-dynamic mode.

According to some embodiments, according to the periodic mode, the wireless device is configured to monitor a control channel for downlink control information according to a periodic duty cycle, wherein according to the periodic mode, the sDCI configuration further comprises an on duration parameter indicating a minimum number of subframes to monitor the control channel during each periodic duty cycle and an inactivity parameter indicating a number of subframes to monitor the control channel upon receiving downlink control information.

According to some embodiments, according to the dynamic mode, the wireless device is configured to monitor a control channel for downlink control information unless the base station provides a dynamic indication of a number of subsequent subframes for which no downlink control information will be provided to the wireless device.

According to some embodiments, according to the hybrid periodic-dynamic mode, the wireless device is configured to determine, in each respective subframe, whether to follow a periodic mode priority or a dynamic mode priority to determine whether to monitor a control channel for downlink control information during the respective subframe or no downlink control information is expected during the respective subframe.

According to some embodiments, at least one sDCI configuration parameter of the sDCI configuration comprises a duration for which the sDCI configuration is enabled.

According to some embodiments, the at least one sDCI configuration parameter of the sDCI configuration selected based at least in part on an application type currently associated with cellular communication between the cellular base station and the wireless device comprises an anchor point parameter selected based at least in part on an average inter-grant distance for the application type currently associated with cellular communication between the cellular base station and the wireless device.

According to some embodiments, the at least one sDCI configuration parameter of the sDCI configuration selected based at least in part on an application type currently associated with cellular communication between the cellular base station and the wireless device comprises a duty cycle parameter selected based at least in part on an average inter-grant distance for the application type currently associated with cellular communication between the cellular base station and the wireless device.

According to some embodiments, the at least one sDCI configuration parameter of the sDCI configuration selected based at least in part on an application type currently associated with cellular communication between the cellular base station and the wireless device further comprises an inactivity parameter indicating a number of subframes to monitor the control channel upon receiving downlink control information.

According to some embodiments, negotiating to enable the sDCI configuration according to the sDCI format further comprises: determining whether channel conditions between the cellular base station and the wireless device are sufficient to support use of the sDCI format.

According to some embodiments, determining whether channel conditions between the cellular base station and the wireless device are sufficient to support use of the sDCI format comprises determining whether a signal to noise ratio (SNR) is below a SNR threshold.

According to some embodiments, determining whether channel conditions between the cellular base station and the wireless device are sufficient to support use of the sDCI format comprises determining whether a Doppler shift is below a Doppler shift threshold.

According to some embodiments, negotiating to enable the sDCI configuration according to the sDCI format is based at least in part on a power state of the wireless device.

According to some embodiments, the method further comprises: disabling the sDCI configuration based on one or more of: a request to terminate use of the sDCI configuration early; a determination that channel conditions between the cellular base station and the wireless device are not sufficient to support use of the sDCI configuration; a change in traffic pattern or of an application type currently associated with cellular communication between the cellular base station and the wireless device; a handover of the wireless device to a different cell; a radio resource control (RRC) reconfiguration or reestablishment; or a RRC connection release.

According to some embodiments, an indication that the downlink control information comprises sDCI is provided using an invalid value in a resource indication value (RIV) field of the downlink control information.

According to some embodiments, the method further comprises, by the cellular base station: detecting a discontinuous transmission in response to the downlink control information; and providing a downlink control information retransmission indicating not to sleep after the one or more subframes for which no downlink control information is provided to the wireless device based at least in part on detecting the discontinuous transmission.

According to some embodiments, the method further comprises, by the wireless device: determining whether the cellular base station provides downlink control information during any subframes for which the wireless device determined that no downlink control information would be provided for an initial detection period after enabling the sDCI configuration.

According to some embodiments, the method further comprises, by the wireless device: determining whether the cellular base station provides any downlink control information initial transmissions having a redundancy version other than 0 during a monitoring period; wherein negotiating with the cellular base station to enable an sDCI configuration according to the sDCI format is performed based at least in part on determining whether the cellular base station provides any downlink control information initial transmissions having a redundancy version other than 0 during the monitoring period.

Still another exemplary embodiment may include a wireless device, comprising: an antenna; a radio coupled to the antenna; and a processing element operably coupled to the radio, wherein the device is configured to implement any or all parts of the preceding examples.

Yet another exemplary embodiment may include an apparatus, comprising a processing element configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

A yet further exemplary set of embodiments may include an apparatus comprising means for performing any or all of the elements of any of the preceding examples.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1-25. (canceled)

26. An apparatus, comprising:
a processor configured to cause a wireless device to:
receive configuration information from a cellular base station indicating that the cellular base station supports a sleep downlink control information (sDCI) format;
provide configuration information to the cellular base station indicating that the wireless device supports the sDCI format;
negotiate with the cellular base station to enable an sDCI configuration according to the sDCI format, wherein:
the sDCI configuration does not affect uplink activity for the wireless device;
the sDCI configuration is enabled independently of discontinuous reception (DRX);
at least one sDCI configuration parameter of the sDCI configuration is selected based at least in part on an application type currently associated with cellular communication between the cellular base station and the wireless device; and
a second sDCI configuration parameter of the sDCI configuration comprises an sDCI operation mode, wherein the sDCI operation mode is a dynamic mode, wherein according to the dynamic mode the processor is further configured to cause the wireless device to:
monitor a control channel for downlink control information unless the cellular base station provides a dynamic indication of a number of subsequent subframes for which no downlink control information will be provided to the wireless device;
receive a first downlink control information message from the cellular base station during a first subframe in accordance with the sDCI configuration, the first downlink control information message comprising a first dynamic indication of a first number of subsequent subframes for which no downlink control information will be provided to the wireless device;
determine one or more future subframes for which no downlink control information will be provided to the wireless device based at least in part on the first dynamic indication; and
determine to perform a first uplink transmission during the one or more future subframes for which no downlink control information will be provided, wherein the first uplink transmission is in response to a grant provided by the first downlink control information message.

27. The apparatus of claim 26,
wherein at least one sDCI configuration parameter of the sDCI configuration comprises a duration for which the sDCI configuration is enabled.

28. The apparatus of claim 26,
wherein the at least one sDCI configuration parameter of the sDCI configuration selected based at least in part on the application type currently associated with cellular communication between the cellular base station and the wireless device comprises:
an anchor point parameter (T1) selected based at least in part on an average inter-grant distance for the application type currently associated with cellular communication between the cellular base station and the wireless device.

29. The apparatus of claim 28,
wherein the determination of the one or more future subframes for which no downlink control information will be provided to the wireless device is based at least in part on scaling the anchor point parameter (T1).

30. The apparatus of claim 26,
wherein the at least one sDCI configuration parameter of the sDCI configuration selected based at least in part on the application type currently associated with cellular communication between the cellular base station and the wireless device comprises:
a duty cycle parameter selected based at least in part on an average inter-grant distance for the application type currently associated with cellular communication between the cellular base station and the wireless device.

31. The apparatus of claim 26,
wherein the at least one sDCI configuration parameter of the sDCI configuration selected based at least in part on the application type currently associated with cellular communication between the cellular base station and the wireless device comprises:
an inactivity parameter indicating a number of subframes to monitor the control channel upon receiving downlink control information.

32. The apparatus of claim 26,
wherein to negotiate to enable the sDCI configuration according to the sDCI format is based at least in part on a power state of the wireless device.

33. The apparatus of claim 26, wherein the processor is further configured to disable the sDCI configuration.

34. The apparatus of claim 33, wherein to disable the sDCI configuration is based at least in part on one or more of:
a determination that channel conditions between the cellular base station and the wireless device are not sufficient to support use of the sDCI configuration;
a change in traffic pattern or of an application type currently associated with cellular communication between the cellular base station and the wireless device;
a handover of the wireless device to a different cell;
a radio resource control (RRC) reconfiguration or reestablishment; or
a RRC connection release.

35. A wireless device, comprising:
a radio; and
a processor operably coupled to the radio and configured to cause the wireless device to:
receive configuration information from a cellular base station indicating that the cellular base station supports a sleep downlink control information (sDCI) format;
provide configuration information to the cellular base station indicating that the wireless device supports the sDCI format;
negotiate with the cellular base station to enable an sDCI configuration according to the sDCI format, wherein:
the sDCI configuration does not affect uplink activity for the wireless device;
the sDCI configuration is enabled independently of discontinuous reception (DRX);
at least one sDCI configuration parameter of the sDCI configuration is selected based at least in part on an application type currently associated with cellular communication between the cellular base station and the wireless device; and
a second sDCI configuration parameter of the sDCI configuration comprises an sDCI operation mode, wherein the sDCI operation mode is a dynamic mode, wherein according to the dynamic mode the processor is further configured to cause the wireless device to:
monitor a control channel for downlink control information unless the cellular base station provides a dynamic indication of a number of subsequent subframes for which no downlink control information will be provided to the wireless device;
receive a first downlink control information message from the cellular base station during a first subframe in accordance with the sDCI configuration, the first downlink control information message comprising a first dynamic indication of a first number of subsequent subframes for which no downlink control information will be provided to the wireless device;
determine one or more future subframes for which no downlink control information will be provided to the wireless device based at least in part on the first dynamic indication; and
determine to perform a first uplink transmission during the one or more future subframes for which no downlink control information will be provided, wherein the first uplink transmission is in response to a grant provided by the first downlink control information message.

36. The wireless device of claim 35,
wherein at least one sDCI configuration parameter of the sDCI configuration comprises a duration for which the sDCI configuration is enabled.

37. The wireless device of claim 35,
wherein the at least one sDCI configuration parameter of the sDCI configuration selected based at least in part on the application type currently associated with cellular communication between the cellular base station and the wireless device comprises:
an anchor point parameter (T1) selected based at least in part on an average inter-grant distance for the application type currently associated with cellular communication between the cellular base station and the wireless device.

38. The wireless device of claim 37,
wherein the determination of the one or more future subframes for which no downlink control information will be provided to the wireless device is based at least in part on scaling the anchor point parameter (T1).

39. The wireless device of claim 35,
wherein the at least one sDCI configuration parameter of the sDCI configuration selected based at least in part on the application type currently associated with cellular communication between the cellular base station and the wireless device comprises:
a duty cycle parameter selected based at least in part on an average inter-grant distance for the application type currently associated with cellular communication between the cellular base station and the wireless device.

40. The wireless device of claim 35,
wherein the at least one sDCI configuration parameter of the sDCI configuration selected based at least in part on the application type currently associated with cellular communication between the cellular base station and the wireless device comprises:
an inactivity parameter indicating a number of subframes to monitor the control channel upon receiving downlink control information.

41. The wireless device of claim 35,
wherein to negotiate to enable the sDCI configuration according to the sDCI format is based at least in part on a power state of the wireless device.

42. The wireless device of claim 35, wherein the processor is further configured to disable the sDCI configuration.

43. The wireless device of claim 42, wherein to disable the sDCI configuration is based at least in part on one or more of:
a determination that channel conditions between the cellular base station and the wireless device are not sufficient to support use of the sDCI configuration;
a change in traffic pattern or of an application type currently associated with cellular communication between the cellular base station and the wireless device;
a handover of the wireless device to a different cell;
a radio resource control (RRC) reconfiguration or reestablishment; or
a RRC connection release.

44. A method, comprising:
at a wireless device:
receiving configuration information from a cellular base station indicating that the cellular base station supports a sleep downlink control information (sDCI) format;
providing configuration information to the cellular base station indicating that the wireless device supports the sDCI format;
negotiating with the cellular base station to enable an sDCI configuration according to the sDCI format, wherein:
the sDCI configuration does not affect uplink activity for the wireless device;
the sDCI configuration is enabled independently of discontinuous reception (DRX);
at least one sDCI configuration parameter of the sDCI configuration is selected based at least in part on an application type currently associated with cellular communication between the cellular base station and the wireless device; and
a second sDCI configuration parameter of the sDCI configuration comprises an sDCI operation mode, wherein the sDCI operation mode is a dynamic mode, wherein according to the dynamic mode the method further comprises:
monitoring a control channel for downlink control information unless the cellular base station provides a dynamic indication of a number of subsequent subframes for which no downlink control information will be provided to the wireless device;
receiving a first downlink control information message from the cellular base station during a first subframe in accordance with the sDCI configuration, the first downlink control information message comprising a first dynamic indication of a first number of subsequent subframes for which no downlink control information will be provided to the wireless device;
determining one or more future subframes for which no downlink control information will be provided to the wireless device based at least in part on the first dynamic indication; and
determining to perform a first uplink transmission during the one or more future subframes for which no downlink control information will be provided, wherein the first uplink transmission is in response to a grant provided by the first downlink control information message.

45. The method of claim 44,
wherein at least one sDCI configuration parameter of the sDCI configuration comprises a duration for which the sDCI configuration is enabled.
